(19) United States
(12) Patent Application Publication
(10) Pub. No.: US 2021/0294001 A1
(43) Pub. Date: Sep. 23, 2021

(54) MOBILE TERMINAL AND METHOD OF CONTROLLING THE SAME

(71) Applicant: LG ELECTRONICS INC., Seoul (KR)

(72) Inventors: Byeongkil KANG, Seoul (KR); Namhee KIM, Seoul (KR); Sungbum JOO, Seoul (KR); Dongjin LEE, Seoul (KR); Jeongho WOO, Seoul (KR)

(73) Assignee: LG ELECTRONICS INC., Seoul (KR)

(21) Appl. No.: 16/911,198

(22) Filed: Jun. 24, 2020

(30) Foreign Application Priority Data
Mar. 18, 2020 (KR) 10-2020-0033160

(51) Int. Cl. G02B 3/14; H04N 5/225; G02B 27/64; G02B 26/00

(52) U.S. Cl. CPC G02B 3/14; G02B 26/005; G02B 27/646; H04N 5/2254

(57) ABSTRACT

For improving AF performance, the mobile terminal includes a liquid lens, a storage configured to store a focal length based on applied voltages at two or more reference temperatures and a valid voltage range corresponding to a valid focal length range at the two or more reference temperatures, and a controller configured to perform compensation on the valid voltage range based on the temperature measured by the temperature sensor, wherein the controller is configured to perform shift-compensation on the valid voltage range when the measured temperature is greater than or equal to a first threshold temperature, a shift amount corresponding to the shift-compensation being a value obtained by applying an interpolation to a shift amount at the two or more reference temperatures, and perform extension-compensation on the valid voltage range when the measured temperature is less than the first threshold temperature.

### CROSS-REFERENCE TO RELATED APPLICATION

Pursuant to 35 U.S.C. § 119(a), this application claims the benefit of earlier filing date and right of priority to Korean Patent Application No. 10-2020-0033160, filed on Mar. 18, 2020, the contents of which are all hereby incorporated by reference herein in its entirety.

### BACKGROUND

### 1. Field

This disclosure relates to a mobile terminal including a camera driven with a liquid lens and a method of controlling the mobile terminal.

### 2. Description of the Related Art

Terminals may be classified into mobile or portable terminals and stationary terminals based on whether to be moved. The mobile terminals may be classified into handheld terminals and vehicle-mounted terminals based on whether to be carried by a user.

Functions of the mobile terminal have been diversified. For example, the mobile terminal may have functions of data and voice communication, image and video shooting through a camera, voice recording, playing a music file through a speaker system, and outputting an image or video on a display. In some terminals, a game playing function is added or a multimedia player function is performed. A recent mobile terminal may receive a multicast signal that provides visual contents such as broadcast, video, or television programs.

According to the diversification in functions, the terminal is implemented in a form of a multimedia player having various functions such as taking a picture or video, playing music or video files, playing a game, receiving broadcasts, and the like.

In order to support and develop the functions of the terminal, it may be considered to improve a structural part and/or software part of the terminal.

A camera field has been consistently required to be improved and is currently being developed to meet this purpose. A camera included in the mobile terminal may have a high-quality and a high-speed performance and also be required to have a small size. In particular, the mobile terminal may often be restricted on a space in a thickness direction of a device, so that a thickness of the camera is also limited.

As the space in which the camera is mounted is limited, an autofocus of the camera may be implemented with restrictions. For example, a VCM-type camera using electromagnetic induction or a hall sensor may have a limitation on an autofocus driving range, which may lead to an increase in size of a mobile terminal.

To prevent this, a camera with a liquid lens may be used. A diopter of the liquid lens may be changed based on a magnitude of a voltage applied to the liquid lens, so that a focal length is changed in response thereto.

The camera with the liquid lens may be more affected by temperature when compared to other-type cameras. Even when the same voltage is applied, the temperature may cause a relatively large diopter deviation. In a case in which the temperature is low, rules for noise may not simple. Also, in this case, a reaction speed of the liquid lens may be reduced. When the reaction speed of the liquid lens is reduced, a command for a subsequent frame may be conducted before a focus movement is completed, which may result in performing an autofocus analysis based on inaccurate information. Due to this, as a result, autofocus completion may be delayed or the autofocus may not be appropriately performed.

Also, such issues may lead to a degradation in resolution at a fixed focus when shooting a video using the camera.

### SUMMARY

An aspect is to prevent a decrease in accuracy or speed of an autofocus and a degradation in resolution during video shooting with a fixed focus when a mobile terminal including a camera with a liquid lens is driven at a low temperature.

According to an aspect, there is provided a mobile terminal with a camera, the mobile terminal including a liquid lens of which a diopter is adjusted based on an applied voltage to adjust a focal length of the camera, a storage configured to store a focal length based on applied voltages at two or more reference temperatures and a valid voltage range corresponding to a valid focal length range at the two or more reference temperatures, a temperature sensor configured to measure a temperature, and a controller configured to perform compensation on the valid voltage range based on the temperature measured by the temperature sensor, wherein the controller is configured to perform shift-compensation on the valid voltage range when the measured temperature is greater than or equal to a first threshold temperature, a shift amount corresponding to the shift-compensation being a value obtained by applying an interpolation to a shift amount at the two or more reference temperatures, and perform extension-compensation on the valid voltage range when the measured temperature is less than the first threshold temperature.

The interpolation applied to the shift amount at the two or more reference temperatures may be a linear interpolation.

The controller may be configured to perform the extension-compensation based on a valid voltage range for the first threshold temperature shift-compensated through the interpolation when the measured temperature is less than the first threshold temperature.

The first threshold temperature may be about 15 degrees Celsius (° C.).

A valid voltage range after the extension-compensation relative to the valid voltage range before the extension-compensation may be about 1.4.

The valid voltage range before the extension-compensation may include an autofocus (AF) moving margin.

The camera may further include a solid lens. A focal length based on applied voltages at two or more reference temperatures and a valid voltage range corresponding to a valid focal length range at the two or more reference temperatures may be values measured based on the camera including the solid lens and the liquid lens.

The camera may further include a solid lens. The controller may be configured to perform shift-compensation on the valid voltage range when the measured temperature is less than the first threshold temperature. A shift amount corresponding to the shift-compensation may be a value obtained by applying an interpolation to a shift amount at the two or more reference temperatures based on the solid lens.

The controller may be configured to increase a frame skip value when the measured temperature is less than a second threshold temperature.

The second threshold temperature may be about 0° C.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 is a block diagram illustrating a mobile terminal according to the present disclosure;

FIGS. 2A and 2B are conceptual diagrams illustrating a mobile terminal viewed in different directions according to the present disclosure;

FIG. 3 is a conceptual diagram illustrating a camera 200 of a mobile terminal according to the present disclosure;

FIG. 4 illustrates an example of comparison between focal lengths and voltages of a camera of a mobile terminal at two temperatures according to the present disclosure;

FIG. 5 illustrates a compensation algorithm to extend an autofocus (AF) range according to the present disclosure;

FIG. 6 is a graph that shows an error rate compared to a room temperature of a camera according to the present disclosure;

FIGS. 7 and 8 are flowcharts illustrating an overall autofocusing process of a mobile terminal according to the present disclosure; and

FIG. 9 is a block diagram illustrating components of a camera and a controller of a mobile terminal according to the present disclosure.

### DETAILED DESCRIPTION

Hereinafter, preferred embodiments of the present disclosure will be described in detail with reference to the accompanying drawings, and the same or similar elements are designated with the same numeral references regardless of the numerals in the drawings and their redundant description will be omitted. A suffix “module” or “unit” used for constituent elements disclosed in the following description is merely intended for easy description of the specification, and the suffix itself does not give any special meaning or function. In describing the present disclosure, moreover, the detailed description will be omitted when a specific description for publicly known technologies to which the invention pertains is judged to obscure the gist of the present disclosure. Also, it should be noted that the accompanying drawings are merely illustrated to easily explain the concept of the invention, and therefore, they should not be construed to limit the technological concept disclosed herein by the accompanying drawings.

The terms ‘first’, ‘second’, etc. may be used to describe various components, but the components are not limited by such terms. The terms are used only for the purpose of distinguishing one component from other components.

When an arbitrary component is described as “being connected to” or “being linked to” another component, this should be understood to mean that still another component(s) may exist between them, although the arbitrary component may be directly connected to, or linked to, the corresponding other component. In contrast, when an arbitrary component is described as “being directly connected to” or “being directly linked to” another component, this should be understood to mean that no component exists between them.

A singular expression can include a plural expression as long as it does not have an apparently different meaning in context.

In the present application, the terms “include” and “have” should be understood to be intended to designate that illustrated features, numbers, steps, operations, components, parts or combinations thereof exist and not to preclude the existence of one or more different features, numbers, steps, operations, components, parts or combinations thereof, or the possibility of the addition thereof.

Mobile terminals described herein include mobile phones, smart phones, laptop computers, digital broadcasting terminals, personal digital assistants (PDAs), portable multimedia players (PMPs), navigation, and slate PCs., Tablet PC (tablet PC), ultrabook, wearable device (for example, a watch-type terminal (smartwatch), glass-type terminal (smart glass), HMD (head mounted display), etc. may be included.

However, the configuration according to the embodiment described in the present specification may be applied to a fixed terminal such as a digital TV, a desktop computer, and a digital signage, except when applicable only to a mobile terminal. It is easy for a technician to know.

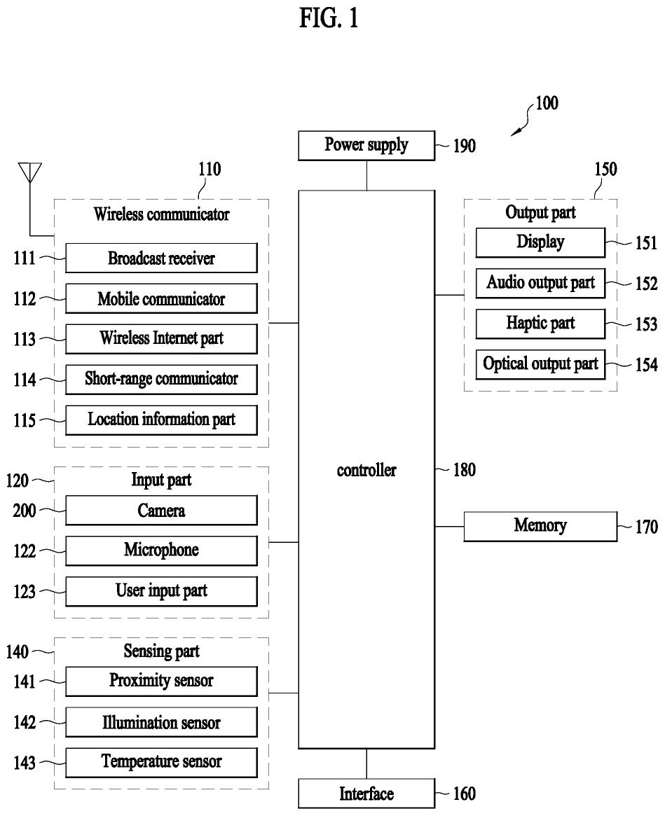

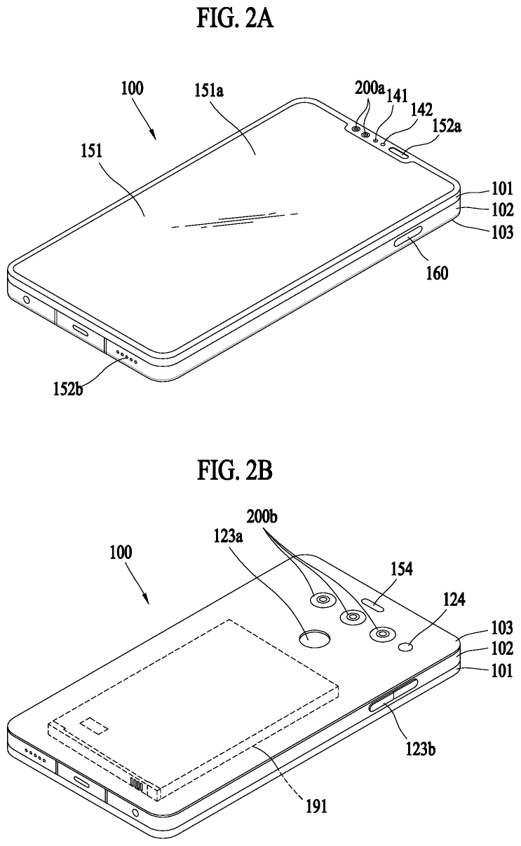

Referring to FIG. 1, FIG. 2A, and FIG. 2B, FIG. 1 is a block diagram illustrating a mobile terminal 100 related to the present invention, and FIGS. 2A and 2B are views of an example of a mobile terminal 100 related to the present invention viewed from different directions.

The mobile terminal 100 may include a wireless communicator 110, an input part 120, a sensing part 140, an output part 150, an interface 160, a memory 170, a controller 180, and a power supply 190. It is understood that implementing all of the components illustrated in FIG. 1 is not a requirement, and that greater or fewer components may alternatively be implemented.

More specifically, the wireless communicator 110 may include one or more modules which enable communications such as wireless communications between the mobile terminal 100 and a wireless communication system, communications between the mobile terminal 100 and another mobile terminal 100, communications between the mobile terminal 100 and an external server. Further, the wireless communicator 110 typically includes one or more modules which connect the mobile terminal 100 to one or more networks.

The wireless communicator 110 may include one or more of a broadcast receiver 111, a mobile communicator 112, a wireless Internet part 113, a short-range communicator 114, and a location information part 115.

The input part 120 may include a camera 200 for obtaining images or video or an image input part, a microphone 122 for inputting an audio signal or an audio input part, a user input part 123 (for example, a touch key, a push key, and the like) for allowing a user to input information, and the like. Voice data or image data collected by the input part 120 may be analyzed and processed into a user's control command.

The sensing part 140 may include one or more sensors configured to sense at least one of internal information of the mobile terminal 100, the surrounding environment of the mobile terminal 100, or user information. For example, the sensing part 140 may include a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, the camera 200), a microphone (for example, the microphone 122), a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from two or more sensors of the aforementioned sensors, and combinations thereof.

The output part 150 is configured to generate various types of output, such as audio, video, tactile output, and the like. The display 151 may be inter-layered with or integrally formed with a touch sensor to facilitate a touch screen. Such a touch screen may provide an output interface between the mobile terminal 100 and a user, as well as function as the user input part 123 which provides an input interface between the mobile terminal 100 and the user.

The interface 160 serves as an interface with various types of external devices that can be coupled to the mobile terminal 100. The interface 160 may include, for example, at least one of a wired or wireless port, an external power supply port, a wired or wireless data port, a memory card port, a port for connecting a device having an identification module, an audio input/output (I/O) port, a video I/O port, or an earphone port. In some cases, the mobile terminal 100 may perform assorted control functions associated with a connected external device, in response to the external device being connected to the interface 160.

The memory 170 stores data to support various functions or features of the mobile terminal 100. For instance, the memory 170 may be configured to store application programs executed in the mobile terminal 100, data or instructions for operations of the mobile terminal 100, and the like. At least some of the application programs may be downloaded from an external server via wireless communication. At least some of the application programs may be installed within the mobile terminal 100 at time of manufacturing or shipping, which is typically the case for basic functions of the mobile terminal 100 (for example, receiving a call, placing a call, receiving a message, sending a message, and the like). Meanwhile, application programs may be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 processes signals, data, information and the like inputted or outputted through the above-mentioned components and/or runs application programs stored in the memory 170, thereby processing or providing appropriate information and/or functions to a user.

In order to execute application programs stored in the memory 170, the controller 180 may control at least some of the above-described components described with reference to FIG. 1. Further, in order to execute application programs stored in the memory 170, the controller 180 may control at least two or more of the components included in the mobile terminal 100 in combination.

Under the control of the controller 180, the power supply 190 receives external power or internal power or provide power to each component included in the mobile terminal 100. The power supply 190 may include a battery, and the battery may be an embedded battery or a replaceable battery.

The power supply 190 may be connected with a power supply port, the power supply port may be configured as an example of the interface 160 to which an external charger for supplying power is electrically connected to charge a battery.

At least one portion of the respective components mentioned in the foregoing description can cooperatively operate to implement operations, controls or controlling methods of the mobile terminal 100 according to various embodiments of the present disclosure mentioned in the following description. Moreover, the operations, controls or controlling methods of the mobile terminal 100 can be implemented in the mobile terminal upon execution of at least one or more application programs stored in the memory 170.

The input unit 120 is for input of image information (or signals), audio information (or signals), data, or information input from a user. For input of image information, the mobile terminal 100 may include one or more camera 200. The camera 200 processes image frames such as still images or moving pictures obtained by an image sensor in a video call mode or a shooting mode. The processed image frame may be displayed on the display unit 151 or stored in the memory 170. Meanwhile, the plurality of cameras 200 provided in the mobile terminal 100 may be arranged to form a matrix structure, and through the plurality of cameras 200 forming the matrix structure, a plurality of image information having various angles or focuses may be input. Also, the plurality of cameras 200 may be arranged in a stereo structure to acquire left and right images for realizing a stereoscopic image.

The camera 200 of the input unit 120 includes at least one of a camera sensor (e.g., CCD, CMOS, etc.), a photo sensor (or image sensor), and a laser sensor.

The camera 200 and the laser sensor may be combined with each other to detect a touch of a sensing target for a 3D stereoscopic image. The photo sensor may be stacked on the display element, which is configured to scan the movement of the sensing object close to the touch screen. More specifically, the photo sensor mounts photo diodes and TRs (transistors) in rows/columns to scan the contents placed on the photo sensor using electrical signals that change according to the amount of light applied to the photo diode. That is, the photo sensor performs coordinate calculation of the sensing object according to the change amount of light, and through this, location information of the sensing object may be obtained.

Referring to FIGS. 2A and 2B, the disclosed mobile terminal 100 has a bar-shaped terminal body. However, the present invention is not limited to this, and may be applied to various structures such as a watch type, a clip type, a glass type, or a folder type, a flip type, a slide type, a swing type, a swivel type to which two or more bodies are movably coupled. It will be related to a specific type of mobile terminal, but the description of a specific type of mobile terminal can be generally applied to other types of mobile terminals.

Here, the terminal body may be understood as a concept of referring to the mobile terminal 100 as at least one aggregate.

The mobile terminal 100 includes a case (for example, a frame, a housing, a cover, and the like) forming the appearance of the mobile terminal. As illustrated, the mobile terminal 100 may include a front case 101 and a rear case 102. Various electronic components are arranged in an inner space formed by coupling of the front case 101 and the rear case 102. At least one middle case may be additionally arranged between the front case 101 and the rear case 102.

The display 151 may be located on the front side of the mobile terminal body to output information. As illustrated, a window 151a of the display 151 may be mounted to the front case 101 to form the front surface of the mobile terminal body together with the front case 101.

In some embodiments, electronic components may also be mounted to the rear case 102. Examples of such electronic components include a detachable battery, an identification module, a memory card, and the like. In this case, a rear cover 102 may be detachably coupled to the rear case 102 to cover the electronic components mounted to the rear case. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. Meanwhile, the rear cover 103 may include an opening for externally exposing a rear camera part 200b, an optical output part 154, a flash 124, a rear input part 123a, and the like.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating various electronic components, the mobile terminal 100 may be configured such that one case forms the inner space. In this example, a mobile terminal 100 having a uni-body is formed in such a manner that synthetic resin or metal extends from a side surface to a rear surface.

Meanwhile, the mobile terminal 100 may include a waterproofing part (not shown) for preventing introduction of water into the mobile terminal body. For example, the waterproofing part may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may be provided with the display 151, the first audio output part 152a, the second audio output part 152b, the proximity sensor 141, the illumination sensor 142, the optical output part 154, a front camera part 200a, a rear camera part 200b, the first manipulating part 123a, the second manipulating part 123b, the microphone 122, the interface 160, and the like.

In the following, it is described by taking an example, as shown in FIGS. 2A and 2B, that the display 151, the first audio output part 152a, the proximity sensor 141, the illumination sensor 142, and the front camera part 200a are arranged at the front side of the mobile terminal body, that the manipulating part 123b, the second audio output part 152b, the microphone 122, and the interface 160 are arranged on a side surface of the mobile terminal body, and that the optical output part 154, the manipulating part 123a, the rear camera part 200b, and the flash 124 are arranged at a rear side of the mobile terminal body.

However, these components are not limited to the above-described arrangement. Such components may be excluded or replaced or arranged on a different surface, when necessary. For example, the manipulating part 123a may not be provided at the rear side of the mobile terminal body, and the second audio output part 152b may be provided not in the side surface of the mobile terminal body, but in the rear surface of the mobile terminal body.

The display 151 may display (output) information processed in the mobile terminal 100. For example, the display 151 may display execution screen information of an application program executing at the mobile terminal 100 or user interface (UI) and graphic user interface (GUI) information in response to the execution screen information.

The display 151 may include at least one of a liquid crystal display (LCD), a thin film transistor-liquid crystal display (TFT-LCD), an organic light emitting diode (OLED), a flexible display, a 3-dimensional (3D) display, or an e-ink display.

The display 151 may be implemented using two display devices, according to an implementing form of the mobile terminal 100. In this case, a plurality of the displays may be arranged on one surface, either spaced apart from each other, or these devices may be integrated, or these devices may be arranged on different surfaces.

In order to receive a control command in a touching manner, the display 151 may include a touch sensor for sensing a touch input received at the display 151. When a touch is input to the display 151, the touch sensor may sense the touch and the controller 180 may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display (not shown) at a rear side of the window 151a, or a metal wire which is patterned directly on the rear surface of the window 151a. Alternatively, the touch sensor may be integrally formed with the display. For example, the touch sensor may be disposed on a substrate of the display or within the display.

As such, the display 151 may also form a touch screen together with the touch sensor. In this case, the touch screen may serve as the user input part 123 (see FIG. 1). In some cases, the touch screen may replace at least some of the functions of the first manipulating part 123a.

The first audio output part 152a may be implemented in the form of a receiver that delivers voice audio to a user's ear, and the second audio output part 152b may be implemented in the form of a loud speaker that outputs various alarm sounds or multimedia audio reproduction.

An aperture for releasing audio generated by the first audio output part 152a may be formed in the window 151a of the display 151. However, aspects of the present disclosure are not limited thereto, and audio may be released along an assembly gap between structural bodies (for example, a gap between the window 151a and the front case 101). In this case, a hole independently formed to output audio sounds may not be seen or may be hidden in terms of appearance, thereby further simplifying the appearance of the mobile terminal 100.

The optical output part 154 is configured to output light for indicating occurrence of an event. Examples of such events include a message reception, a call signal reception, a missed call, an alarm, a schedule notice, an email reception, information reception through an application, and the like. When a user has checked a generated event, the controller 180 can control the optical output part 154 to stop outputting light.

The front camera part 200a processes image frames such as still or moving images obtained by the image sensor in a capture mode or a video call mode. The processed image frames may be displayed on the display 151 and may be stored in the memory 170.

The first and second manipulating parts 123a and 123b are examples of the user input part 123 that is manipulated to receive a command for controlling operation of the mobile terminal 100. The first and second manipulating parts 123a and 123b may employ any tactile method that allows the user to perform manipulation such as touch, push, scroll, or the like. In addition, first and second manipulating parts 123a and 123b may employ any non-tactile method that allows the user to perform manipulation such as proximity touch, hovering, or the like.

The manipulating part 123a may be in the form of a mechanical key or a combination of a touch key and a mechanical key. In addition, the manipulating part 123a may be in the form layered with a finger scan sensor.

Input to be received by the first and second manipulating parts 123a and 123b may be set in various ways. For example, an input to a menu, a home key, cancellation, search, or the like may be input, and an input to control a volume level being output from the first or second audio output part 152a or 152b, to switch to a touch recognition mode of the display 151, or the like may be input.

As another example of the user input part 123, a rear input part (not shown) may be located at the rear side of the mobile terminal body. The rear input part is manipulated to receive an input for controlling operation of the mobile terminal 100. The input may be set in a variety of different ways. For example, the rear input part may receive an input for power on/off, start, end, scroll, control volume level being output from the first or second audio output part 152a or 152b, switch to a touch recognition mode of the display 151, and the like. The rear input part may be configured to allow a touch input, a push input, or combinations thereof.

The rear input part may be located to overlap the display 151 of the front side in a thickness direction of the mobile terminal body. As one example, the rear input part may be located on an upper end portion of the rear side of the mobile terminal body such that a user can easily manipulate it using a forefinger when the user grabs the mobile terminal body with one hand. However, aspects of the present disclosure are not limited thereto, and the position of the rear input part may change.

As such, when the rear input part is provided at the rear side of the mobile terminal body, a new type of user interface may be implemented using the rear input part. In addition, when the first manipulating part 123a is not located at the front side of the mobile terminal body since the aforementioned touch screen or the rear input part substitute for at least some functions of the first manipulating part 123a provided at the front side of the mobile terminal body, the display 151 may be in the form of a larger screen.

Meanwhile, the mobile terminal 100 may include a finger scan sensor for recognizing a user's fingerprint. The controller 180 may use fingerprint information sensed by the finger scan sensor as part of an authentication procedure. The finger scan sensor may be embedded in the display 151 in the user input part 123.

The microphone 122 is configured to receive a user's voice, other sound, and the like. The microphone 122 may be provided in plural to receive stereo sound.

The interface 160 serves as a path allowing the mobile terminal 100 to interface with an external device. For example, the interface 160 may include one or more of a connection mobile terminal for connecting to another device (for example, an earphone, an external speaker, or the like), a port for near field communication (for example, an Infrared Data Association (IrDA) port, a Bluetooth port, a wireless LAN port, and the like), or a power supply port for supplying power to the mobile terminal 100. The interface 160 may be implemented in the form of a socket for accommodating an external card, such as Subscriber Identification Module (SIM), User Identity Module (UIM), or a memory card for information storage.

The rear camera part 200b may be located at the rear side of the mobile terminal body. In this case, the rear camera part 200b may have an image capturing direction substantially opposite to that of the front camera part 200a.

The rear camera part 200b may include a plurality of camera.

The flash 124 may be located adjacent to the rear camera part 200b. When an image of a subject is captured with the rear camera part 200b, the flash 124 may illuminate the subject.

The second audio output part 152b may be additionally arranged in the mobile terminal body. The second audio output part 152b may implement stereophonic sound functions in conjunction with the first audio output part 152a, and may be also used for implementing a speaker phone mode for call communication.

At least one antenna for wireless communication may be located on the mobile terminal body. The antenna may be installed in the mobile terminal body or formed by the case. For example, an antenna which configures a part of the broadcast receiver 111 may be retractable into the mobile terminal body. Alternatively, an antenna may be in the form of a film attached to an inner surface of the rear cover 103 or in the form of a case including a conductive material.

A power supply 190 (see FIG. 1) for supplying power to the mobile terminal 100 may be provided at the mobile terminal body. The power supply 190 may include a battery 191 embedded in in the mobile terminal body or detachably coupled to an outside of the mobile terminal body.

The battery 191 may be configured to receive power via a power source cable connected to the interface 160. Also, the battery 191 may be configured to be recharged in a wireless manner using a wireless charger. Wireless charging may be implemented by magnetic induction (electromagnetic resonance).

Meanwhile, in the drawing, the rear cover 103 is coupled to the rear case 102 for shielding the battery 191, to prevent separation of the battery 191, and to protect the battery 191 from an external impact or from foreign material. When the battery 191 is detachable from the mobile terminal body, the rear case 103 may be detachably coupled to the rear case 102.

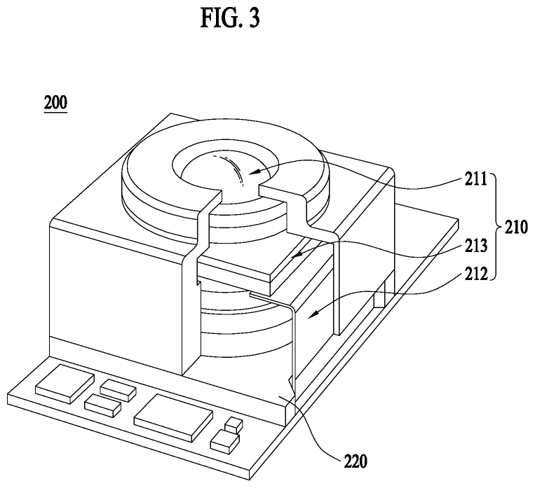

FIG. 3 is a conceptual diagram illustrating a camera 200 of a mobile terminal 100 according to the present disclosure.

The camera 200 includes a lens part 210 and an image sensor 220. The lens part 210 may receive and refract light reflected from an object. The image sensor 220 may convert the received light into a digital signal to generate an image.

The lens part 210 may be implemented as a set of lenses of a plurality of members. In the present disclosure, specifically, the lens part 210 may include a liquid lens 211. The lens part 210 may include the liquid lens 211, and may also include a combination of a solid lens 212 and the liquid lens 211.

The solid lens 212 may be formed of a light-transmitting material having a stiffness sufficient to prevent deformation by an external force, such as plastic or glass. In this case, there may be no or little change in diopter due to a voltage application or the like, but a temperature may cause a change in diopter.

A diopter of the liquid lens 211 may be changed based on a magnitude of an applied voltage. The change in diopter may determine a focal length of the camera 200. The focal length may decrease when a relatively high voltage is applied to the liquid lens 211 and increase when a relatively low voltage is applied to the liquid lens 211.

Focus adjustment using such principle may be used for autofocus (AF) driving. A type of autofocus may include a phase-difference detection type using a phase difference for each region of an acquired image and an active type for detecting a distance from an object by radiating waves such as ultrasonic waves, infrared rays, or lasers to the object. Technical characteristics of the present disclosure are not limited to the aforementioned types of autofocus. Irrespective of a description being given of an example relating to any one of those types, the present disclosure is not limited to the example.

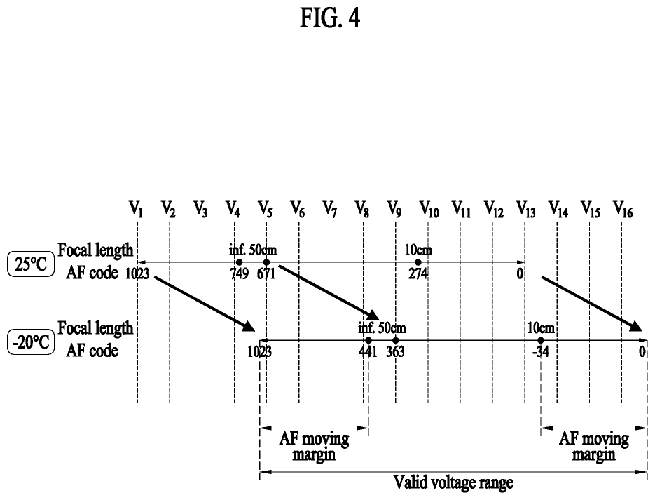

FIG. 4 illustrates an example of comparison between a valid voltage ranges representing a focal length of a camera of a mobile terminal at two temperatures according to the present disclosure.

As described above, a diopter of a liquid lens may be affected by a temperature in addition to an applied voltage. When the temperature is changed, a voltage required for acquiring the same diopter of the liquid lens may be changed. As illustrated in FIG. 4, while a voltage V₅ is allocated to acquire a focal length of 50 centimeters (cm) at a temperature of 25 degrees Celsius (° C.), a voltage V₉ may be allocated to acquire the same focal length, 50 cm, at a temperature of −20° C. As such, a voltage may be applied based on a temperature of a camera or a mobile terminal including the camera.

For the autofocus driving, a valid voltage range may be set to smoothly perform autofocusing. For example, a controller may set a valid voltage range for performing the autofocus and apply a voltage within the valid voltage range. The valid voltage range may also be referred to as an AF range. The AF range may be set based on a focal length range in which the camera is to be driven (e.g., infinity (inf.) to 10 cm), that is, a valid focal length range.

If the set AF range is excessively wide, an autofocusing speed may be decreased. Thus, it is desirable to set a small AF range if possible. However, even in this case, a minimum valid focal length range may be included in the AF range. A surplus area exceeding the valid focal length range may be referred to as an AF moving margin, which is an area reflecting a physical behavior of the AF driving.

Even in the same valid focal length range, valid voltage ranges may be different at temperatures of 25° C. and −20° C. Thus, the AF range may be differently set based on the temperature.

The AF range may be set in a form of AF codes on a controller. In this case, a voltage may be mapped to each of the AF codes.

Referring to FIG. 4, for example, a minimum value of the AF codes is zero and a maximum value of the AF codes is 1023. In a case in which the temperature is 25° C., an AF code of 1023 corresponds to V₀, an AF code of 0 corresponds to V₁₃, and an AF code of 671 corresponds to V₅. In contrast, it can be known that an AF code allocated to the voltage V₅ is not 671 at the temperature of −20° C.

The AF range is affected by a manufacturing tolerance of a liquid lens of a camera and thus, needs to be confirmed for each product. However, since it is impossible to measure a value for all temperatures and all focal lengths of each product, data in each product to be referenced (hereinafter, referred to as ‘reference data’) may be acquired and other data remaining values for other temperatures and other focal lengths may be uniformly applied based on a compensation algorithm with a predetermined rule.

The reference data may be measured for two or more reference temperatures. For example, reference temperatures of two points may be two temperatures between 25° C. and 60° C.

The reference data may include a valid voltage range at the corresponding reference temperature and a valid focal length range, in addition to each value.

The reference data may be stored in a memory.

As illustrated in FIG. 4, the AF range for achieving the same valid focal length range may differ at 25° C. and −20° C. That is, the AF range may need to be changed. For example, the AF range of the reference temperature may be compensated for a change in temperature.

Shift-compensation may be defined if the AF range has the same width before and after compensation as shown in FIG. 4. In other words, the same width may indicate that a difference between a minimum voltage and a maximum voltage is the same at each temperature.

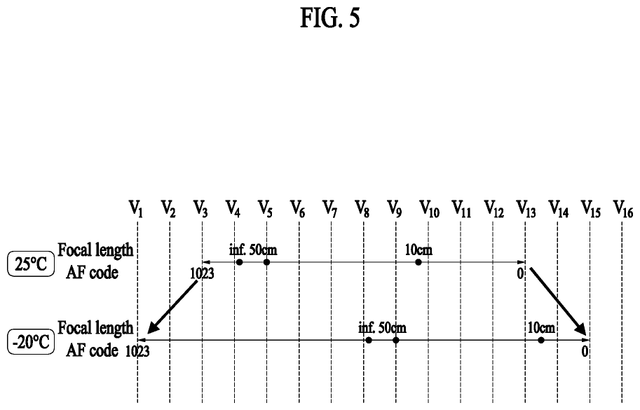

FIG. 5 illustrates a compensation algorithm to extend an AF range according to the present disclosure. FIG. 4 is also referenced for ease of description.

Referring to FIG. 5, compensation may be performed to obtain different widths of AF ranges. The compensation in such cases may be defined as extension-compensation.

In the present disclosure, the extension-compensation, shift-compensation, or a combination of the extension-compensation and the shift-compensation may be performed for the AF range based on a measured temperature. Requirements for each case are described below.

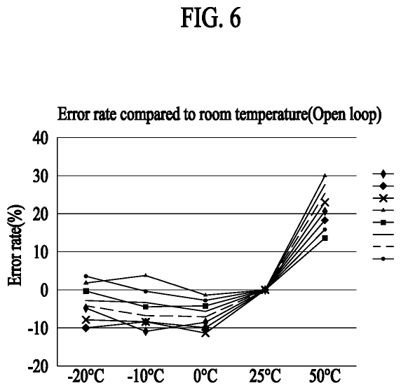

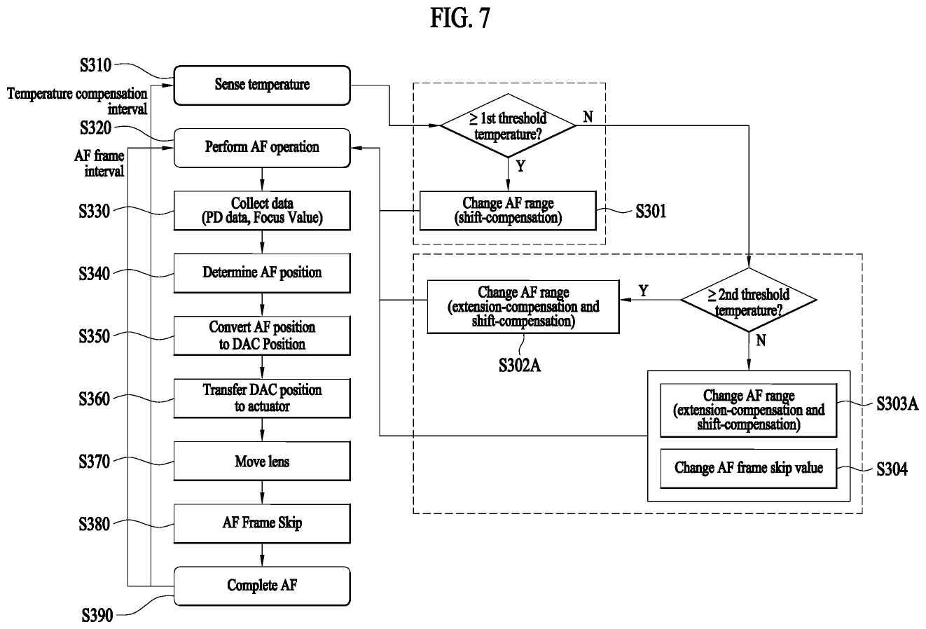

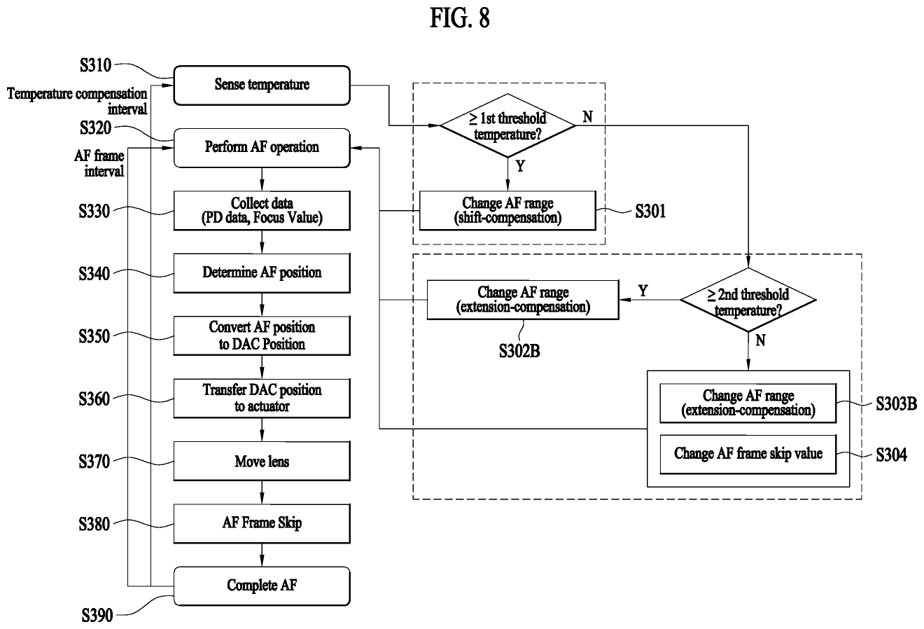

FIG. 6 is a graph that shows an error rate compared to a room temperature of a camera according to the present disclosure. FIGS. 7 and 8 are flowcharts illustrating an overall autofocusing process of a mobile terminal according to the present disclosure.

The graph of FIG. 6 shows a difference (error) in focal length at a corresponding temperature relative to a focal length at a room temperature obtained when the same voltage is applied to a liquid lens of a camera including the liquid lens and a solid lens. In the graph, the difference is represented by percentile.

As shown in the graph, in a high-temperature range, an error rate is relatively high and a change in error rate is regular. In contrast, in a low-temperature range, an error rate is relatively low and a change in error rate is irregular.

In the present disclosure, a different compensation algorithm may be applied to each case by reflecting a difference in camera behavior characteristics in the high-temperature range and the low-temperature range.

Specifically, since an error rate in a high-temperature area has a relatively regular variation, a compensation algorithm having a predetermined regularity may be applied. In terms of a low-temperature area, since an error rate is not regular but has a relatively small width, an extensive compensation algorithm may be comprehensively applied to cover such variation.

A temperature that is a boundary between the high-temperature area and the low-temperature area may be defined as a first threshold temperature. In this case, the high-temperature area may be defined as a range of a temperature greater than or equal to the first threshold temperature. Also, the low-temperature area may be defined as a range of a temperature less than the first threshold temperature. As an experiment result, it was confirmed that the first threshold temperature is about 15° C. desirably. This can be determined based on a density, a material, a size, and a shape of a liquid lens and thus, may be variable. As such, based on the experiment result, the first threshold temperature may be specified as a value between 10° C. and 20° C.

In the present disclosure, based on such characteristics of the high-temperature area and the low-temperature area, compensation may be applied differently in the high-temperature area and the low-temperature area.

—High-temperature area temperature compensation: AF range shift—

As described above, the high-temperature area may have a regular change in error rate. Thus, for the high-temperature area, shift-compensation may be performed to shift a predetermined portion of a valid voltage range (e.g., AF range) at a reference temperature in operation S301. A degree of the shifting may be represented in a form of first-degree equation corresponding to an error-rate change tendency. In other words, the AF range in the high-temperature area may be changed so that an applied voltage change ΔV (e.g., shift amount) relative to a temperature change ΔT is constant. ΔV/ΔT may be calculated based on reference data of the two reference temperatures described above. For example, when the two reference temperatures are 30° C. and 40° C., and when a shift amount of a valid voltage range at the two reference temperatures is 5 volts (V), ΔV/ΔT may be 0.5 V/T. Based on this, a valid voltage range of 35° C. may be “valid voltage range of 30° C.+5*0.5,” so that a shift amount may be 2.5 V (e.g., linear interpolation).

In some cases, instead of the linear interpolation, a second- or higher-degree polynomial relationship may be deduced and applied. In such cases, reference data for more reference temperatures may be required.

—Low-temperature area temperature compensation (common): AF range extension—

As described above, in the low-temperature area, a valid voltage range with temperature may be irregular and not have a first-degree polynomial relationship. However, since a degree of the irregularity is relatively small, extension-compensation may be performed for a valid voltage range in operations S302 and S303.

Specifically, through such extension, a minimum value may be decreased by A based on the AF range at the reference temperature and may be increased by A based on a maximum AF code.

—Low-temperature area temperature compensation addition (FIG. 7): including AF range shift—

In addition to compensation for extending a valid voltage range, shift-compensation may be applied together in operations S302A and S303A. In this case, in contrast to the above-described shift-compensation for the high-temperature area, a shift amount may not change with temperature and a shift amount at a first threshold temperature may apply to the entire low-temperature area. The shift amount at the first threshold temperature may be obtained by obtaining the applied shift amount of the first-degree equation described above. In other words, a valid voltage range at each temperature in the low-temperature area may be the same as a shift-compensated valid voltage range at the first threshold temperature.

AF range extension may be performed after the shift-compensation of the low-temperature area.

—Low-temperature area temperature compensation addition (FIG. 8): not including AF range shift—

In some cases, shift-compensation may not be applied in operations S302B and S303B. In such cases, instead of the shift-compensation, only extension-compensation may be applied in a valid voltage range obtained at the reference temperature.

Even when the shift-compensation is not applied, it is desirable to apply shift-compensation of a valid voltage range according to a temperature of a solid lens. Because the reference data is data of a camera including both liquid lens and solid lens, variation due to the solid lens may be reflected even when compensation associated with the liquid lens is not performed. An amount of shift-compensation associated with the solid lens may be applied in the same manner as an interpolation which is a scheme of shift-compensation performed in the high-temperature area.

A controller may perform the following operations in sequence. When autofocusing starts in operation S320, the controller may collect data such as a phase difference (PD), data, a focus value, and the like of an object, or image data of the object in operation S330 and determine an AF position based on the collected data in operation S340. In operation S350, the controller may convert the determined AF position into a digital-to-analog converter (DAC) position. The AF position or the DAC position obtained based on the collected data may be determined within the AF range described above.

In operation S360, the controller may transfer the DAC position to an actuator. The actuator may be a device for providing a driving force to change a diopter of a lens. In terms of the liquid lens, the actuator may be a circuit component for applying a voltage.

When the diopter of the liquid lens is changed in operation S370, an autofocusing process corresponding to a single AF frame may terminate in operation S390. Thereafter, the controller may return to operation S320 again and repeat the autofocusing process until an AF result satisfies at least a preset condition. A time for which the autofocusing process is performed once may be referred to as an AF frame interval. The AF frame interval may be, for example, 33 milliseconds (ms).

As the AF frame interval is reduced, an autofocusing speed may increase. In this case, however, a subsequent autofocusing process may be performed before a lens movement, that is, a change of the diopter of the liquid lens, performed in a current autofocusing process is completed. From this, an inaccurate autofocusing result may be obtained because data is collected while not being in a static state in which a change of the diopter is completed. To prevent this, in operation S380, the controller may delay the AF frame interval of the corresponding turn through an AF frame skip process.

The delay may be achieved by performing the AF frame skip process to which an allocated AF frame skip value is reflected. For example, if an allocated AF frame skip value is 0, the delay may be 0 ms (=33 ms*0). In this example, an AF frame may be performed at intervals of 33 ms without delaying. If an allocated AF frame skip value is 1, the delay may be 33 ms (=33 ms*1). In this case, the delay of 33 ms may occur, so that an AF frame is performed at intervals of 66 ms. If an allocated AF frame skip value is 2, the delay may be 66 ms (=33 ms*2). In this case, the delay of 66 ms may occur, so that an AF frame is performed at intervals of 99 ms.

A diopter change of the liquid lens in the low-temperature area may require a greater time when compared to a diopter change of the liquid lens in the high-temperature area. Thus, when a temperature measured by a temperature sensor is less than a second threshold temperature, the controller may delay a subsequent autofocusing operation by allocating a greater AF frame skip value than that allocated in a case in which the measured temperature is greater than or equal to the second threshold temperature.

Here, the second threshold temperature may not be necessarily the same as the first threshold temperature described above. For example, the first threshold temperature may be 15° C. and the second threshold temperature may be 0° C.

As described above, each autofocusing operation may be performed based on the determined AF range and AF frame skip value. Thus, based on a temperature measured by a temperature sensor of a mobile terminal at preset time intervals, the controller may allocate an AF range and an AF frame skip value. The preset time interval may be defined as a temperature compensation interval. The temperature compensation interval may be, for example, one second (sec.) or 5 sec., and determined based on a property of the liquid lens, power consumption in a temperature compensation process, and the like, comprehensively.

For example, the first threshold temperature may be 15° C. and the second threshold temperature may be 0° C. When a temperature measured by the temperature sensor is greater than or equal to 15° C., a high-temperature compensation algorithm, that is, shift-compensation for an AF range based on a first-degree equation may be performed. When a temperature measured by the temperature sensor is less than 15° C., compensation may be performed to extend the AF range. Specifically, when the measured temperature is less than 15° C., an AF range shift corresponding to the temperature of 15° C. may be additionally performed or AF range shift-compensation corresponding to the solid lens may be additionally performed.

Also, when the measured temperature is less than 0° C., the controller may allocate a greater AF frame skip value than an AF frame skip value allocated in a case in which the measured temperature is greater than or equal to 0° C. For example, the AF frame skip value allocated when the measured temperature is greater than or equal to 0° C. may be 1, and the AF frame skip value allocated when the measured temperature is less than 0° C. may be 2.

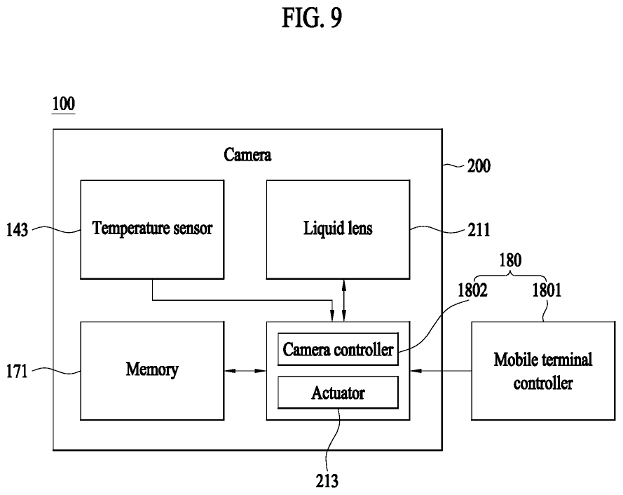

FIG. 9 is a block diagram illustrating components of the camera 200 and the controller 180 of the mobile terminal 100 according to the present disclosure.

A temperature sensor 143 measures a temperature of the mobile terminal 100. Ideally, the temperature sensor 143 may directly measure a temperature of the liquid lens 211.

High-temperature area temperature compensation and low-temperature area temperature compensation may be performed by the controller 180. The controller 180 includes a mobile terminal controller 1801 used for overall operations of a mobile terminal, or a camera controller 1802. The mobile terminal controller 1801 may be a system-on-chip (SOC) or an application processor (AP). The camera controller 1802 may be mounted on the camera 200 and used for operating the camera 200.

The high-temperature area temperature compensation and the low-temperature area temperature compensation may be performed by one of the mobile terminal controller 1801 and the camera controller 1802. Alternatively, one of the high-temperature area temperature compensation and the low-temperature area temperature compensation may be performed by the mobile terminal controller 1801 and the other one may be performed by the camera controller 1802.

Desirably, the low-temperature area temperature compensation may be performed by the mobile terminal controller 1801. Since an autofocus operation is performed in the mobile terminal controller 1801, for example, an AP, when the low-temperature area temperature compensation including a process of changing the AF frame skip value is performed in the mobile terminal controller 1801, an autofocus delay may be minimized in addition to minimizing power consumption and a possibility of error occurrence may be reduced.

Reference data may be stored in a memory. The memory may be the memory 170 for the entire mobile terminal 100 or a separate memory 171 for storing only data related to a camera.

A mobile terminal of the present disclosure is described as follows.

According to at least one example embodiment of the present disclosure, it is possible to increase an autofocusing speed at a low temperature.

Further, according to at least one example embodiment of the present disclosure, it is possible to minimize power consumption for autofocusing.

Further, according to at least one example embodiment of the present disclosure, it is possible to improve an accuracy of autofocusing.

Further, according to at least one example embodiment of the present disclosure, it is possible to solve a degradation in resolution occurring when shooting a fixed-focus video.

Additional ranges of possibilities will become apparent from the following detailed description. It should be understood, however, that the detailed description and specific examples, such as the preferred embodiments of the invention, are given by way of illustration only, since various changes and modifications within the spirit and scope of the disclosure will be apparent to those skilled in the art.

It is apparent to those skilled in the art that the present disclosure may be materialized in other specific forms without departing from the essential characteristics of the present disclosure.

The present disclosure described above can be embodied as computer readable codes on a medium in which a program is recorded. The computer-readable medium includes all kinds of recording devices in which data that can be read by a computer system is stored. Examples of computer-readable media include hard disk drives (HDDs), solid state disks (SSDs), silicon disk drives (SDDs), ROMs, RAMs, CD-ROMs, magnetic tapes, floppy disks, optical data storage devices, and the like. This also includes implementations in the form of carrier waves (e.g., transmission over the Internet). In addition, the computer may include the controller of the terminal device. Accordingly, the above detailed description should not be construed as limiting in all aspects and should be considered as illustrative. The scope of the invention should be determined by reasonable interpretation of the appended claims, and all changes within the equivalent scope of the disclosure are included in the scope of the disclosure.

What is claimed is:

1. A mobile terminal with a camera, the mobile terminal comprising:
a liquid lens of which a diopter is adjusted based on an applied voltage to adjust a focal length of the camera;
a storage configured to store a focal length based on applied voltages at two or more reference temperatures and a valid voltage range corresponding to a valid focal length range at the two or more reference temperatures;
a temperature sensor configured to measure a temperature; and
a controller configured to perform compensation on the valid voltage range based on the temperature measured by the temperature sensor,
wherein the controller is configured to:
perform shift-compensation on the valid voltage range when the measured temperature is greater than or equal to a first threshold temperature, a shift amount corresponding to the shift-compensation being a value obtained by applying an interpolation to a shift amount at the two or more reference temperatures; and
perform extension-compensation on the valid voltage range when the measured temperature is less than the first threshold temperature.

2. The mobile terminal of claim 1, wherein the interpolation applied to the shift amount at the two or more reference temperatures is a linear interpolation.

3. The mobile terminal of claim 1, wherein the controller is configured to perform the extension-compensation based on a valid voltage range for the first threshold temperature shift-compensated through the interpolation when the measured temperature is less than the first threshold temperature.

4. The mobile terminal of claim 1, wherein the first threshold temperature is about 15 degrees Celsius (° C.).

5. The mobile terminal of claim 1, wherein a ratio of the valid voltage range after the extension-compensation to the valid voltage range before the extension-compensation is about 1.4.

6. The mobile terminal of claim 5, wherein the valid voltage range before the extension-compensation includes an autofocus (AF) moving margin.

7. The mobile terminal of claim 1, wherein the camera further comprises a solid lens, and
Wherein a focal length based on applied voltages at two or more reference temperatures and a valid voltage range corresponding to a valid focal length range at the two or more reference temperatures are values measured based on the camera including the solid lens and the liquid lens.

8. The mobile terminal of claim 1, wherein the camera further comprises a solid lens,
the controller is configured to further perform shift-compensation on the valid voltage range when the measured temperature is less than the first threshold temperature, and
a shift amount corresponding to the shift-compensation is a value obtained by applying an interpolation to a shift amount at the two or more reference temperatures based on the solid lens.

9. The mobile terminal of claim 1, wherein the controller is configured to increase a frame skip value when the measured temperature is less than a second threshold temperature.

10. The mobile terminal of claim 9, wherein the second threshold temperature is about 0° C.

11. The mobile terminal of claim 9, wherein an AF frame interval is about 33 milliseconds (ms),
the increased frame skip value is 2, and
a temperature measurement interval of the temperature sensor is between one second and five seconds, inclusive.

12. The mobile terminal of claim 9, wherein the controller comprises:
a mobile terminal controller used for driving the mobile terminal; and
a camera controller used for driving the camera, and
the increasing of the frame skip value is performed by the mobile terminal controller.

13. A method of controlling a mobile terminal, the method comprising:
measuring a temperature;
performing shift-compensation on a valid voltage range when the measured temperature is greater than or equal to a first threshold temperature and performing extension-compensation on a valid voltage range when the measured temperature is less than the first threshold temperature; and
performing autofocusing based on the compensated valid voltage range.

14. The method of claim 13, wherein a shift amount of the shift-compensation is a value obtained by applying an interpolation to a valid voltage range shift amount at two or more reference temperatures, and
the extension-compensation is performed based on a valid voltage range for the first threshold temperature shift-compensated by applying the interpolation when the measured temperature is less than the first threshold temperature.

15. The method of claim 13, further comprising:
increasing a frame skip value when the measured temperature is less than a second threshold temperature,
wherein the second threshold temperature is less than the first threshold temperature.
